(19) United States
(12) Patent Application Publication
(10) Pub. No.: US 2012/0218307 A1
(43) Pub. Date: Aug. 30, 2012

(54) ELECTRONIC DEVICE WITH TOUCH CONTROL SCREEN AND DISPLAY CONTROL METHOD THEREOF

(75) Inventors: Hung-Yi Lin, Taipei City (TW); Wen-Shiu Hsu, Taipei City (TW); Jung-Hsing Wang, Taipei City (TW); Ping-Cheng Hsieh, Taipei City (TW)

(73) Assignee: ASUSTeK COMPUTER INC., Taipei (TW)

(21) Appl. No.: 13/402,005

(22) Filed: Feb. 22, 2012

(30) Foreign Application Priority Data
Feb. 25, 2011 (TW) 100106506

(51) Int. Cl. G09G 5/00

(52) U.S. Cl. 345/660

(57) ABSTRACT

A display control method of a touch control screen and an electronic device applying the same are provided. The method is for enlarging a specific zone at the touch control screen and for the user to edit or selection at the enlarged zone. The method includes steps of: determining whether a plurality of first touch points stay at the touch control screen over a predetermined time; enlarging a partial zone image for showing an enlarged zone on the touch control screen; providing a second touch point on the enlarged zone for generating a corresponding position signal; and scaling the position signal, generating a converted signal and inputting the converted signal to a control module.

This application claims the benefit of Taiwan application Serial No. 100106506, filed Feb. 25, 2011, the subject matter of which is incorporated herein by reference.

### BACKGROUND OF THE INVENTION

1. Field of the Invention

The invention relates to an electronic device and a display control method thereof and, more particularly, to an electronic device with a touch control screen and a display control method thereof.

2. Description of the Related Art

As computer technology develops, the computer system has a big change which is to utilize a touch control screen and brings more convenient. Consequently, users control and input commands to computers simply via touching (or tapping) instead of clicking by a mouse.

In the most popular operation systems, only some specific programs support the scale function for users to re-size the viewing images. However, it encounters the problems that not all the images or command input areas can be scaled on the touch control screen for users to edit or taps in a partial enlarged zone, which is rather inconvenient.

Taking the editing function as an example, FIG. 1a is a schematic diagram showing an image editor in a program. A toolbar 110 is displayed at the touch control screen 100 when the program is executed, and the toolbar 110 includes multiple user interfaces, such as a start button 112 and a network state icon 114. When an image editor 120 (such as a drawing tool) is executed, the window of the image editor 120 also includes corresponding user interfaces, such as a close button 122, a maximize button 124 and a minimize button 126.

If the user wants to input a letter “w” in the input area of the operation interface, he or she moves a finger 150 at an editing window 128 of the touch control screen 100. However, sometimes users' finger 150 is too big to make a precise and correct touch input, or even to draw a small figure in a small input area.

Taking the tap for select function as an example, FIG. 1b is a conventional user interface of an operating system. The user interface of the operation system displays multiple touch icons (such as the touch icons A to H) at the touch control screen 100 for taping by users. As shown in FIG. 1b, sometimes the size of the touch icons on the screen is small, when the user uses a finger 150 to tap the target icon, it is easy to mis-tap the icons around the target ones. For example, as shown in FIG. 1b, the user wants to tap the touch icon “F”, however, the icon “B” might be tapped by mistake, which is inconvenient.

### BRIEF SUMMARY OF THE INVENTION

A display control method of a touch control screen and an electronic device applying the same are disclosed. The method includes the following steps: determining whether a plurality of first touch points stay at the touch control screen over a predetermined time; enlarging a partial zone image for showing an enlarged zone on the touch control screen; providing a second touch point on the enlarged zone for generating a corresponding position signal; and scaling the position signal, generating a converted signal and inputting the converted signal to a control module.

An electronic device with a touch control screen is also disclosed. The electronic device includes a touch unit, a filter unit, a gesture engine, an image magnifier module and a control module. The touch unit generates a plurality of first position signals according to a plurality of first touch points at the touch control screen. The filter unit outputs the first position signals. The gesture engine receives the first position signals, determines whether the first touch points stay at the touch control screen over a predetermined time and determines whether to enlarge a partial zone image accordingly. The image magnifier module makes the touch control screen display the enlarged zone when the image magnifier module enlarges the partial zone image according to the gesture engine. A second touch point at the enlarged zone generates a corresponding position signal, and after the filter unit scales the position signal, a converted signal is generated by the filter unit and inputted to the control module.

These and other features, aspects and advantages of the present invention will become better understood with regard to the following description, appended claims, and accompanying drawings.

### BRIEF DESCRIPTION OF THE DRAWINGS

FIG. 1a is a schematic diagram showing an image editor of a conventional operating system;

FIG. 1b is a schematic diagram showing a tap action in the conventional operating system;

FIG. 2 is a schematic diagram showing architecture of a touch control screen in an embodiment;

FIG. 3a to FIG. 3c are flow charts showing steps of a display control method for an electronic device with a touch control screen in an embodiment;

FIG. 4a to FIG. 4c are schematic diagrams showing display and control steps of an editing action in an embodiment; and

FIG. 5a to FIG. 5f are schematic diagrams showing display control steps of a tap for select action and an image moving action in an embodiment.

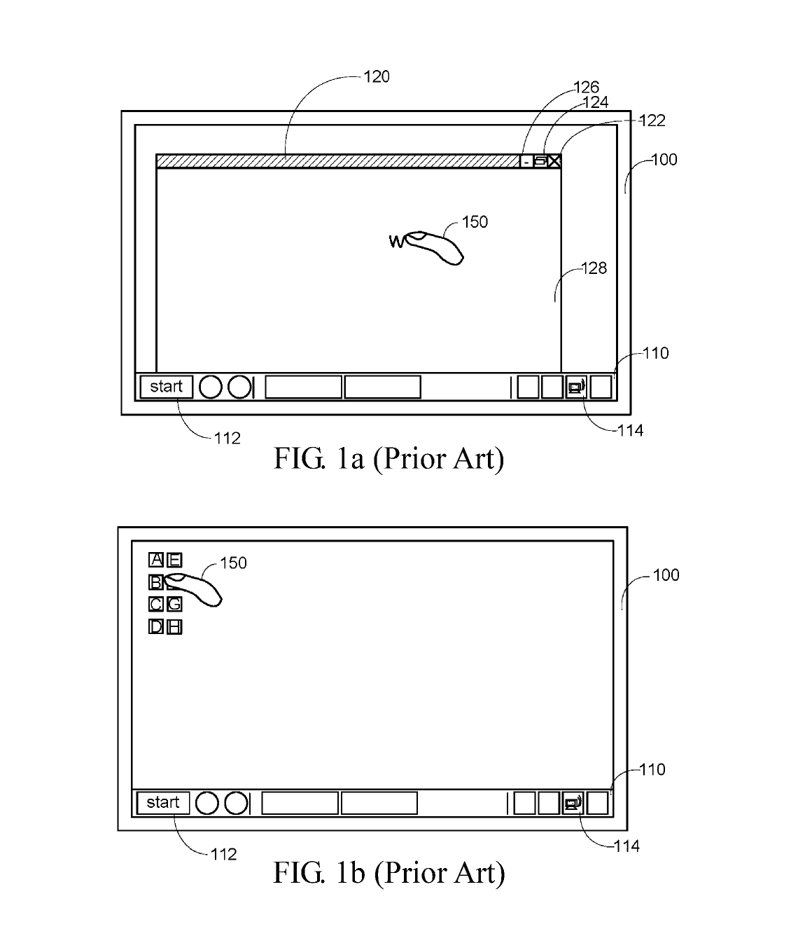

### DETAILED DESCRIPTION OF THE EMBODIMENTS

An electronic device with a touch control screen and a display control method thereof are disclosed. The electronic device equips multiple application modules and driver modules. When the user uses two fingers (that is, a plurality of first touch points) and stays on the touch control screen over a predetermined time, it is determined that the user wants to enlarge a partial zone image. Then, the touch control screen displays an enlarged zone, and the user uses gestures to input control commends in the enlarged zone. When the user controls by gestures, a position signal corresponding to a second touch point is scaled to generate a corresponding converted signal, and the operation system executes the gesture control action, such as editing, selecting or image moving, according to the converted signal.

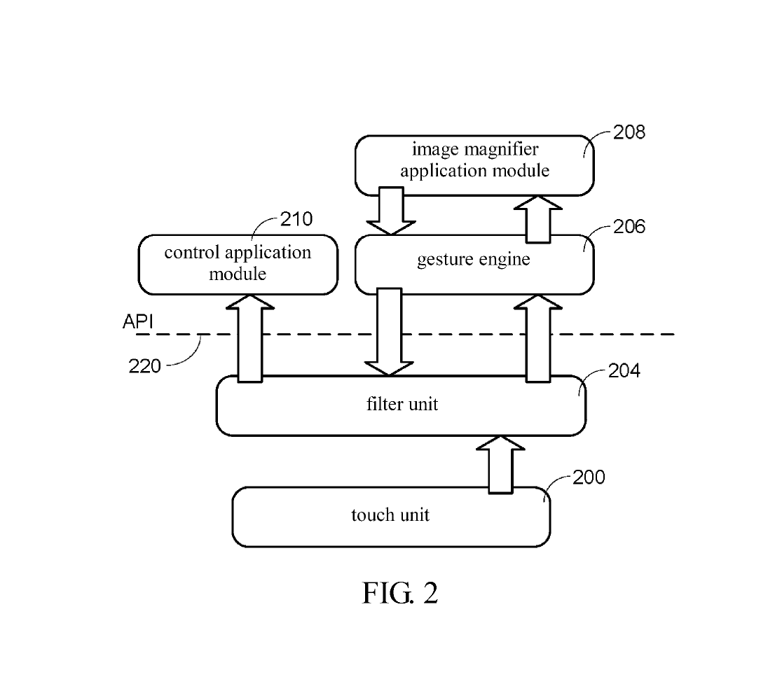

FIG. 2 is a schematic diagram showing architecture of a touch control screen in an embodiment. The touch control screen includes a touch unit 200 and a filter unit 204. In an embodiment, the touch unit 200 may be a driver module of the touch control screen, the driver module outputs the position signal according to the touch points at the touch control screen, and the position signal may be a coordinate signal. In an embodiment, the filter unit 204 may also be a driver module. It can receive the position signal outputted by the touch unit 200 and filter the position signal. In an embodiment, the filter unit 204 may also be a firmware, which is not limited herein.

In an embodiment, the touch control screen may also include a gesture engine 206, an image magnifier module 208 and a control module 210. In an embodiment, the filter unit 204 transmits the position signal with the gesture engine 206 and the control module 210 via an application program interface (API). In an embodiment, the control module 210 may be a Windows control application program of the Microsoft Windows operation system.

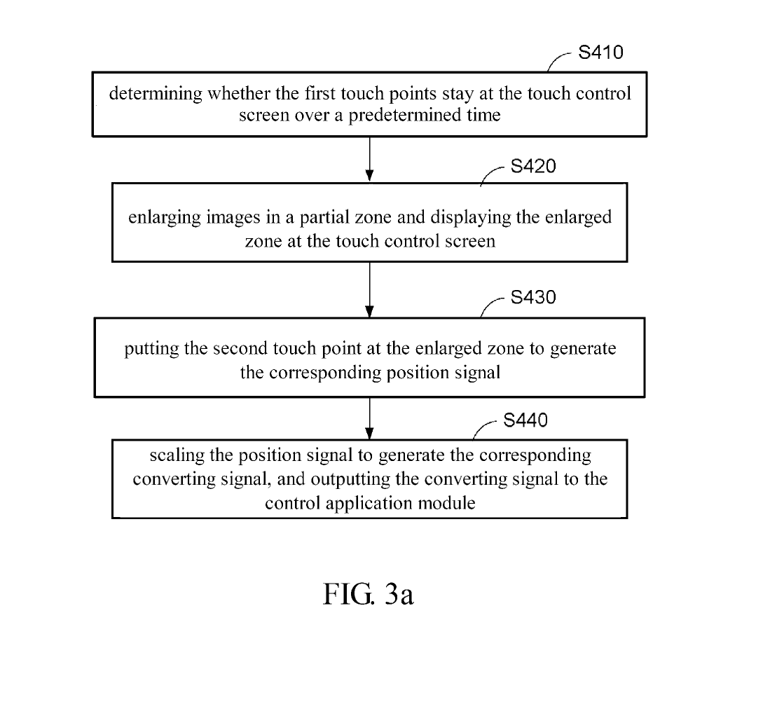

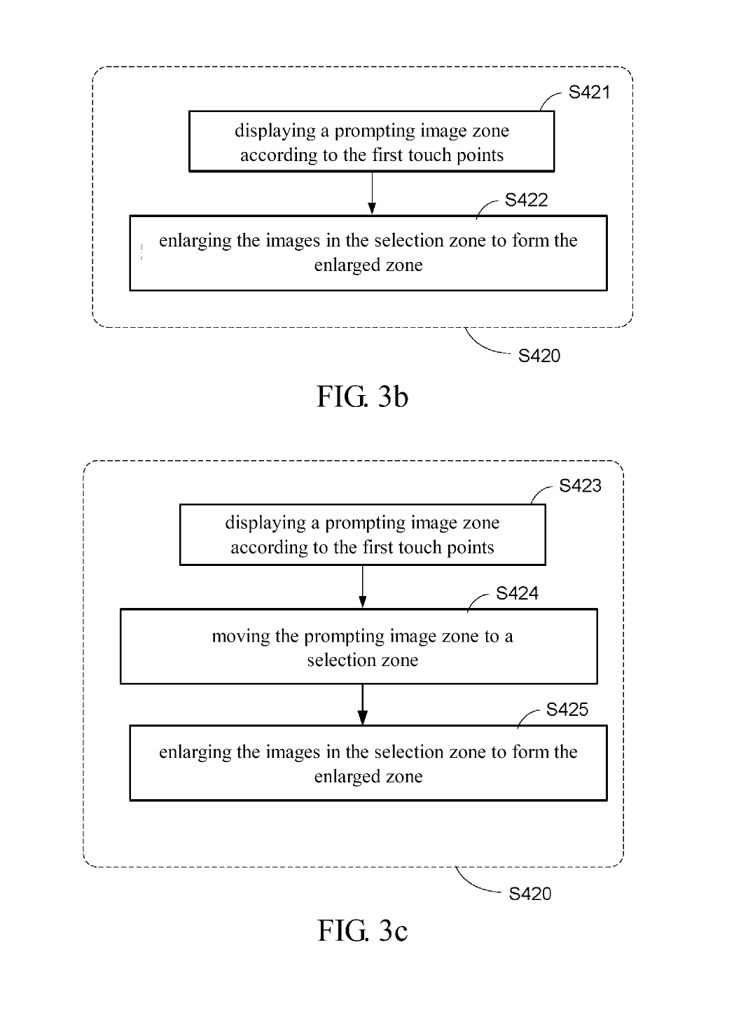

FIG. 3a is a flow chart showing steps of a display control method for an electronic device with a touch control screen in an embodiment. The electronic device includes the touch unit 200, the driver module of the filter unit 204 and the gesture engine 206, the image magnifier module 208 and the control module 210, as shown in FIG. 2.

First, it is determined whether the first touch points stay at the touch control screen over a predetermined time (Step S410). A partial zone image is enlarged and the touch control screen displays the enlarged zone (Step S420). A second touch point is touched at the enlarged zone to generate the corresponding position signal (Step S430). The position signal is scaled and the converted signal is generated correspondingly and outputted to the control module (Step S440).

The Step S420 can be achieved in different ways. As shown in FIG. 3b, a prompting image zone is displayed according to the first touch points (Step S421). Then, the images in the prompting image zone are enlarged to form the enlarged zone (S422). As shown in FIG. 3c, the Step S420 may also be achieved in another way. The prompting image zone is displayed according to the first touch points (Step S423). The prompting image zone is moved to a selection zone (Step S424). Then, the images in the selection zone are enlarged to form the enlarged zone (S425). The details are illustrated in the followings.

In an embodiment, when the user wants to input a small letter or a tiny figure on the touch control screen, two fingers (that is, the first touch points) has to be touched on the screen over the predetermined time, and it is determined the user wants to enlarge the images in a partial zone. Then, the user executes the gesture control action in the enlarged zone of the touch control screen. In the gesture control action, the position signal corresponding to the second touch point is scaled to generate the corresponding converted signal, and the operation system executes the gesture control action according to the converted signal. The gesture control action includes editing, tapping for selecting, image moving and so on.

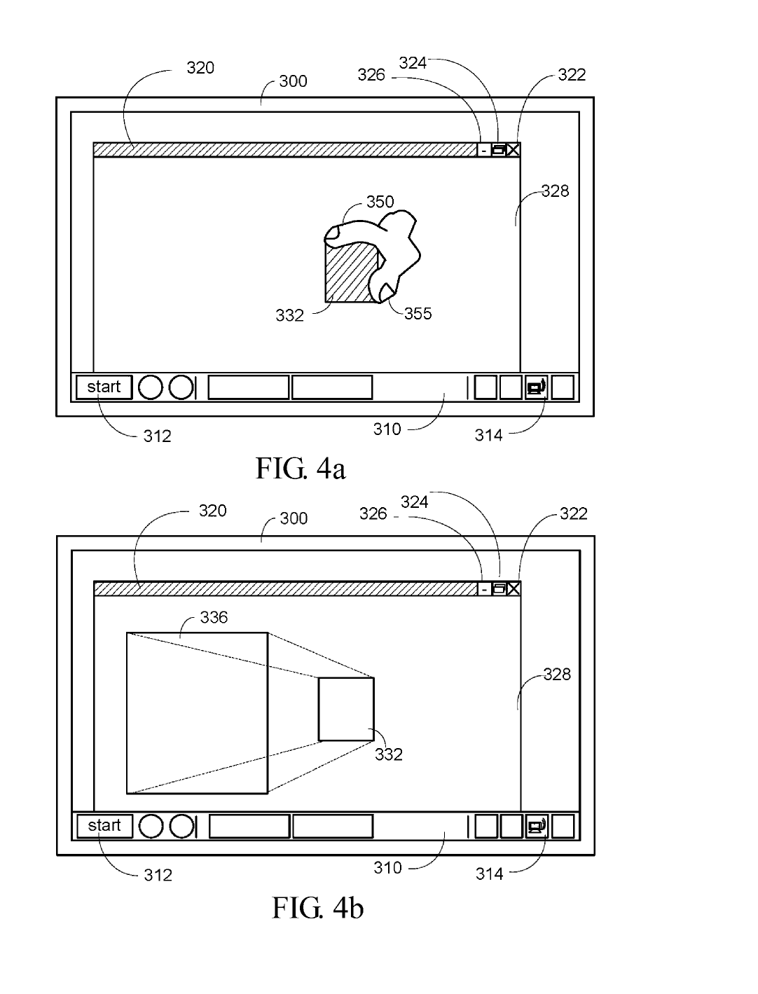

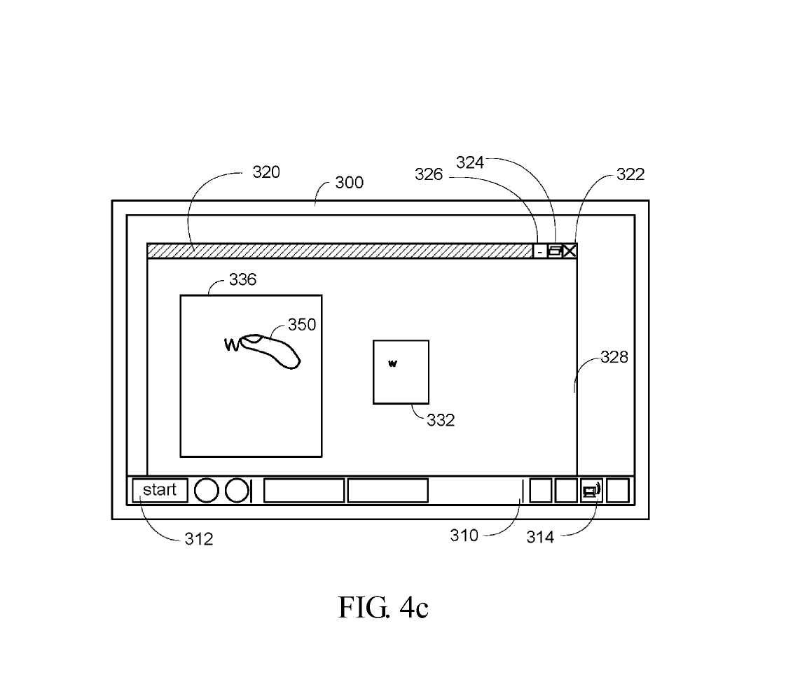

FIG. 4a to FIG. 4c are schematic diagrams showing display and control steps of an editing action in an embodiment. Referring to FIG. 3a and FIG. 3b, the operation system displays a toolbar 310 at the touch control screen 300, and the toolbar 310 includes multiple user interfaces such as a start button 312 and a network state icon 314. When an image editor 320 (such as a drawing tool) is executed in the operation system, the window of the image editor 320 also includes corresponding user interfaces such as a close button 322, a maximize button 324 and a minimize button 326.

If the user wants to input a small letter “w”, he or she should first put two fingers 350 and 355 on an editing window 328 of the touch control screen 300. The touch unit 200 transmits the position signals corresponding to the two fingers 350 and 355 to the filter unit 204 and the gesture engine 206.

The main function of the gesture engine 206 is to determine whether the user wants to enlarge the partial zone image using two fingers 350 and 355. In FIG. 4a, when the user puts the two fingers 350 and 355 (two touch points) on the touch control screen 300 over the predetermined time, the gesture engine 206 determines that the user wants to execute the image enlarging action. That is, the gesture engine 206 continuously detects whether the two position signals change. If the two position signals do not change over the predetermined time, such 0.5 second, the gesture engine 206 confirms that the user wants to execute the image enlarging action. At the time, the two position signals are transmitted to the image magnifier module 208.

When the image magnifier module 208 receives the two position signals, a prompting image zone 332 defined by the two position signals is displayed. In other words, when the user put two fingers 350 and 355 on the touch control screen 300 over the predetermined time, the prompting image zone 332 is displayed at the touch control screen 300. The prompting image zone 332 may be a highlight image or a flash image.

As shown in FIG. 4b, when the user moves the two fingers 350 and 355 away from the touch control screen 300, the touch control screen 300 displays the enlarged zone 336. That is, when the user moves the two fingers 350 and 355 away from the touch control screen 300, the image magnifier module 208 enlarges the images in the prompting image zone 332 and converts the prompting image zone 332 to the enlarged zone 336. The coordinate range of the enlarged zone 336 is transmitted to the gesture engine 206 and the filter unit 204.

As shown in FIG. 4c, when the user edits and draws in the enlarged zone 336, the touch unit 200 transmits the position signal corresponding to the finger 350 to the image magnifier module 208, and the figure drawn by the user is displayed.

The filter unit 204 scales the position signal, generates the converted signal and inputs it to the control module 210. That is, although the user can see, edit and draw figure in the enlarged zone 336, the figures are actually displayed in the prompting image zone 332. Consequently, the filter unit 204 converts all the position signals in the enlarged zone 336 to the converted signals, and inputs the converted signals to the control module 210. The control module 210 displays the small figure in the prompting image zone 332 of the touch control screen 300 according to the converted signals.

In other words, although the user edits and draws in the enlarged zone 336, and the corresponding position signals are not in the prompting image zone 332, the filter unit 204 scales the position signals and converts them to the converted signals. All the converted signals are in the prompting image zone 332, and thus the control module 210 generates small figures.

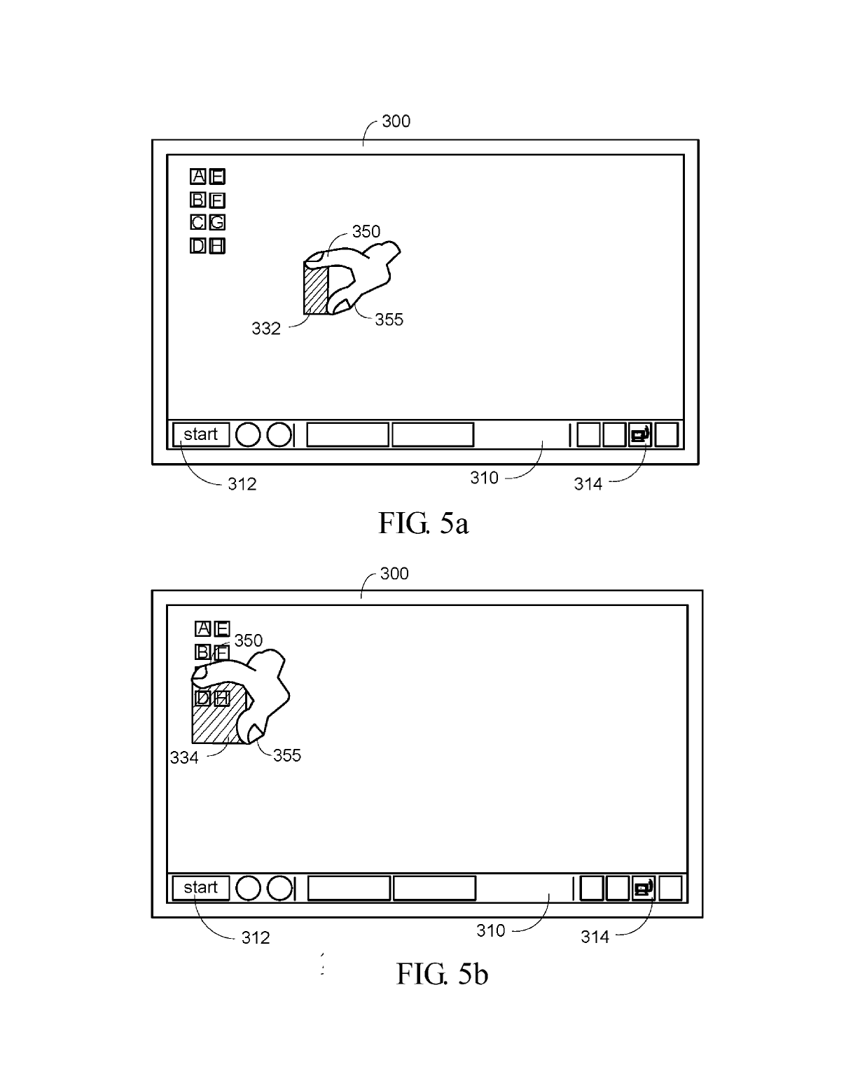

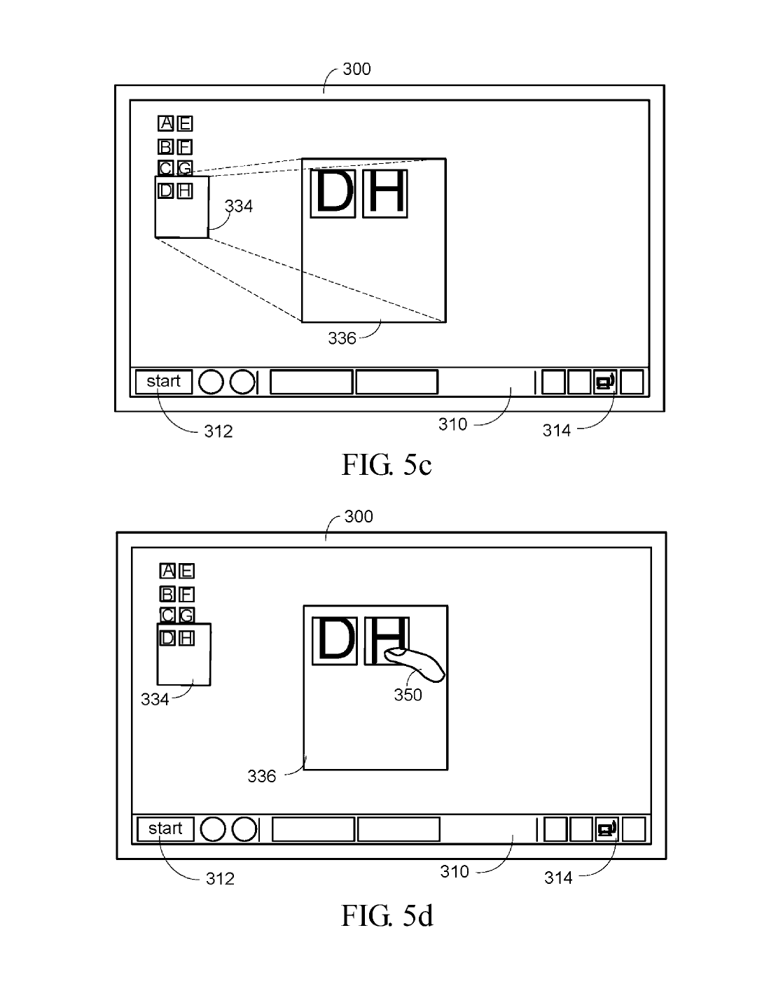

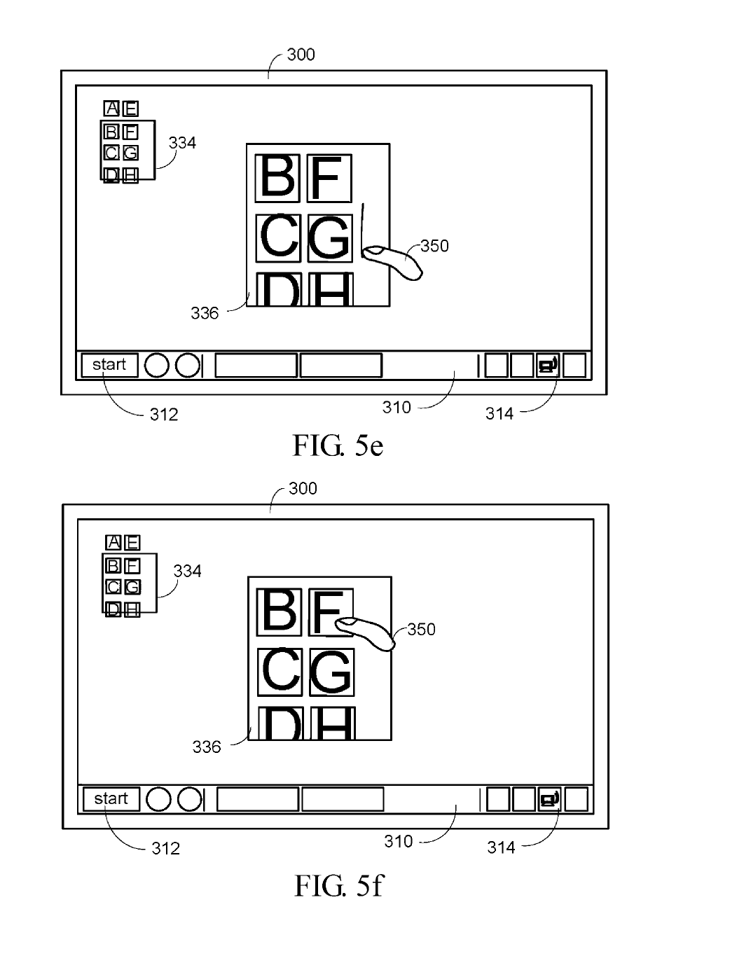

FIG. 5a to FIG. 5f are schematic diagrams showing display control steps of a tap for selecting action and an image moving action in an embodiment. Referring to FIG. 3a and FIG. 3c, the operation system displays multiple touch icons (such as the touch icons A to H) at the touch control screen 300 for selecting.

If the user wants to select one of the touch icons, he or she should first put two fingers 350 and 355 at the touch control screen 300. The touch unit 200 transmits the position signals corresponding to the two fingers 350 and 355 to the filter unit 204 and the gesture engine 206.

The main function of the gesture engine 206 is to determine whether the user wants to enlarge the images in the partial zone using two fingers 350 and 355. As shown in FIG. 5a, when the user puts the two fingers 350 and 355 (the first touch points) on the touch control screen 300 over the predetermined time, the gesture engine 206 determines that the user wants to execute the image enlarging action. That is, the gesture engine 206 continuously detects whether the two position signals change. If the two position signals do not change over the predetermined time, such 0.5 second, the gesture engine 206 confirms that the user wants to execute the image enlarging action. At the time, the two position signals are transmitted to the image magnifier module 208.

When the image magnifier module 208 receives the two position signal, a prompting image zone 332 defined by the two position signals is displayed. In other words, when the user put two fingers 350 and 355 on the touch control screen 300 over the predetermined time, the prompting image zone 332 is displayed at the touch control screen 300 to prompt the user to execute a further action. The prompting image zone 332 may be a highlight image or a flash image.

When the prompting image zone 332 is displayed, the user moves the two fingers 350 and 355 to a zone for the gesture control action. That is, the touch unit 200 continuously transmits the two position signals to the gesture engine 206 and the image magnifier module 208. The image magnifier module 208 continuously changes the size and the position of the prompting image zone 332 according to the two position signals. As shown in FIG. 5b, the user finally selects the selection zone 334 and moves the two fingers 350 and 355 away from the touch control screen 300.

As shown in FIG. 5c, the enlarged zone 336 is displayed at the touch control screen 300. That is, the user may move the two fingers 350 and 355 to any position to define the selection zone 334. When the fingers 350 and 355 move away from the touch control screen 300, the image magnifier module 208 enlarges the images in the selection zone 334, converts the selection zone 334 to the enlarged zone 336 and displays the enlarged zone 336 at the touch control screen 300. At the time, the coordinate range of the enlarged zone 336 is transmitted to the gesture engine 206 and the filter unit 204.

As shown in FIG. 5d, the user can select in the enlarged zone 336. The finger 350 tap on the enlarged touch icon “H”, and the position signal is transmitted to the image magnifier module 208. At the same time, the filter unit 204 scales the position signal, generates the converted signal and inputs the converted signal to the control module 210. The converted signal is at the touch icon “H” in the selection zone 334. That is, although the user taps on the enlarged touch icon “H” in the enlarged zone 336, the filter unit 204 converts the position signal in the enlarged zone 336 to the converted signal, and then inputs the converted signal to the control module 210.

Since the converted signal is at the touch icon “H” in the selection zone 334, the control module 210 confirms that the user taps on the touch icon “H”.

The user may also move the frame to tap on the other touch icons. As shown in FIG. 5e, the user moves the finger 350 downwards in the enlarged zone 336 and generates the corresponding position signal. The position signal is transmitted to the filter unit 204, the gesture engine 206 and the image magnifier module 208, and the image magnifier module 208 moves the frame. That is, the touch icons “C”, “G”, “B” and “F” are displayed in the enlarged zone 336 in sequence.

As shown in FIG. 5f, the user can tap on the enlarged zone 336. The finger 350 taps on the enlarged touch icon “F”, and the corresponding position signal is transmitted to the image magnifier module 208. The filter unit 204 scales the position signal and generates the converted signal, the converted signal is inputted to the control module 210, and the converted signal is at the enlarged touch icon “F” in the enlarged zone 334. That is, although the user taps on the enlarged touch icon “F” in the enlarged zone 336, the filter unit 204 converts the position signal at the enlarged zone 336 to the converted signal, and then the converted signal is inputted to the control module 210.

Since the converted signal is at the touch icon “F” in the selection zone 334, the control module 210 confirms the user taps on the touch icon “F”.

In sum, the electronic device with the touch control screen includes multiple application modules and driver modules. The electronic device may be a desktop computer, a portable tablet or a notebook computer. When the user defines the prompting image zone or the selection zone to edit and draw, the enlarged zone is displayed first at the touch control screen for the user to edit and draw. When the user operates in the enlarged zone, the corresponding position signal is scaled and converted to the converted signal, and the converted signal is inputted to the control module. Consequently, the operation system executes the gesture control action according to the converted signal. Thus, the mistakes due to the finger size in operation of the electronic device can be avoided.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A display control method of a touch control screen of an electronic device, the display control method comprising:
determining whether a plurality of first touch points stay at the touch control screen over a predetermined time;
enlarging a partial zone image for showing an enlarged zone on the touch control screen;
providing a second touch point on the enlarged zone for generating a corresponding position signal; and
scaling the position signal, generating a converted signal and inputting the converted signal to a control module.

2. The display control method of the touch control screen according to claim 1, wherein in the step of enlarging a partial zone image for showing an enlarged zone on the touch control screen, the enlarged zone is formed according to a prompting image zone that configured by the first touch points.

3. The display control method of the touch control screen according to claim 1, wherein in the step of enlarging a partial zone image for showing an enlarged zone on the touch control screen, is to display a prompting image zone, and move the prompting image zone to a selection zone, and the images in the selection zone are enlarged to form the enlarged zone.

4. The display control method of the touch control screen according to claim 3, wherein the prompting image zone is formed by the first touch points.

5. The display control method of the touch control screen according to claim 1, wherein after the converted signal is inputted to the control module, it displayed at the touch control screen.

6. The display control method of the touch control screen according to claim 1, wherein the electronic device includes a touch unit, the touch unit receives the input of the first touch points or the input of the second touch point and response accordingly.

7. The display control method of the touch control screen according to claim 1, wherein the second touch point is provided to generate the position signal to perform the editing, selecting or images moving responses.

8. An electronic device with a touch control screen, comprising:
a touch unit, generating a plurality of first position signals according to a plurality of first touch points at the touch control screen;
a filter unit, outputting the first position signals;
a gesture engine, receiving the first position signals, determining whether the first touch points stay at the touch control screen over a predetermined time and determining whether to enlarge a partial zone image accordingly;
an image magnifier module, making the touch control screen display an enlarged zone when the image magnifier module enlarges the partial zone image according to the gesture engine; and
a control module;
wherein, after a second touch point is provided at the enlarged zone to generate a corresponding position signal, and the filter unit scales the position signal, a converted signal is generated by the filter unit and input to the control module.

9. The electronic device with the touch control screen according to claim 8, wherein the second touch point is provided to generate the position signal to perform the editing, selecting or images moving responses.

10. The electronic device with the touch control screen according to claim 8, wherein the control module displays the converted signal at the touch control screen.

11. The electronic device with the touch control screen according to claim 8, wherein the image magnifier module forms a prompting image zone according to the first touch points, and the partial zone image in the prompting image zone is enlarged to form the enlarged zone.

12. The electronic device with the touch control screen according to claim 8, wherein after the image magnifier module forms a prompting image zone according to the first touch points, and moves the prompting image zone to a selection zone, the partial zone image in the selection zone is enlarged to form the enlarged zone.
